(19) United States
(12) Patent Application Publication
(10) Pub. No.: US 2024/0375495 A1
(43) Pub. Date: Nov. 14, 2024

(54) VEHICLE HARDTOP ASSEMBLY

(71) Applicant: APG, LLC, Garden Grove, CA (US)

(72) Inventor: George Patrick Gemayel, Santa Ana, CA (US)

(21) Appl. No.: 18/641,152

(22) Filed: Apr. 19, 2024

Related U.S. Application Data
(60) Provisional application No. 63/466,161, filed on May 12, 2023.

(51) Int. Cl. B60J 7/10

(52) U.S. Cl. CPC B60J 7/106

(57) ABSTRACT

A vehicle hardtop assembly is described. The vehicle hardtop assembly features a top roof panel, a back panel frame, a first side panel, and a second side panel. The back rear frame is configured to attach to the top roof panel via a first set of fasteners. The back rear frame includes a back rear panel oriented with an offset angle ranging between ten and twenty degrees from vertical and a rear window pivotally coupled to the back rear panel. The first side panel is configured to attach to the top roof panel via a second set of fasteners. The second side panel is configured to attach to the top roof panel via a third set of fasteners,

### CROSS-REFERENCE TO RELATED APPLICATIONS

This application claims the benefit of priority on U.S. Provisional Patent Application No. 63/466,161 filed May 12, 2023, the entire contents of which are incorporated by reference herein.

### FIELD

Embodiments of the disclosure generally relate to the automotive field. More specifically, one embodiment relates to a vehicle hardtop assembly that is transported as a multi-component assembly and built through arrangement and fastening of these components.

### GENERAL BACKGROUND

For many decades, automobiles have provided persons with a method of transit. Most automobiles are built over an assembly line, where a hardtop roof assembly is attached to the chassis of the automobile. Normally, the hardtop roof assembly is a monolithic structure, which is typically manufactured off-site from the assembly line and delivered intact. Given their large, monolithic designs, roof assemblies are difficult to transport and difficult to store at the assembly plant. A multi-component hardtop, which can be constructed at the point of assembly, may be useful to resolve supply chain issues as well as transport and storage issues.

### BRIEF DESCRIPTION OF THE DRAWINGS

Embodiments of the disclosure are illustrated by way of example and not by way of limitation in the figures of the accompanying drawings, in which like references indicate similar elements and in which:

FIG. 1 is a perspective view of an exemplary embodiment of a vehicle installed with a multi-component hardtop roof assembly having an architecture that supports on-site construction at the automobile manufacturer.

FIG. 2A is a first perspective view of an exemplary embodiment of the assembled multi-component hardtop roof assembly of FIG. 1 with a rear window positioned in a closed state.

FIG. 2B is a second perspective view of an exemplary embodiment of the assembled multi-component hardtop roof assembly of FIG. 1 with a rear window positioned in an opened state.

FIG. 3 is an exploded view of hardtop roof assembly of FIG. 2 illustrating multiple components forming the hardtop roof assembly and their fastening scheme.

FIG. 4 is an overhead view of the hardtop roof assembly of FIG. 2 with a rear window oriented in an open position.

FIG. 5 is a side view of the hardtop roof assembly of FIG. 4 with the rear glass panel oriented in a closed position having a first angular offset from vertical.

FIG. 6 is a side view of the hardtop roof assembly of FIG. 4 with the rear glass panel oriented in an open position and held in place by window lift support struts.

FIG. 7 an exploded side view of the hardtop roof assembly of FIG. 5.

FIG. 8 is a rear view of the hardtop roof assembly of FIG. 6.

FIG. 9 is a disassembled hardtop roof assembly with multiple components packaged for transport.

### DETAILED DESCRIPTION

Various embodiments of the disclosure relate to a hardtop roof assembly constructed from multiple components such as a top roof frame, a pair of side roof frames, and a back roof frame for example. In a detached state, these roof frames may be stored and transported. At time of assembly, however, the roof frames may be attached together to form the hardtop roof assembly.

According to one embodiment of the disclosure, each side roof frame features a side roof panel that maintains a side rear window. The side roof panels are configured for coupling to a chassis of the vehicle. The back roof frame features a back roof panel with a pivotal rear window supported by brackets secured to the back roof panel. The back roof panel is configured for coupling to both a tailgate, namely a back portion of a chassis for a vehicle, and D-pillars interposed between the back roof panel and each of the side roof frames. The back roof panel is angularly offset by a prescribed inward angle from the vertically oriented tailgate.

As will be discussed below, the hardtop roof assembly allows for separated components during transport.

### I. Terminology

In the following description, certain terminology is used to describe features of the invention. For example, in certain situations, the terms “frame,” “panel,” and “member” are representative of physical components constructed to form part of a hardtop roof assembly. The term “attach” and other tenses of the term (e.g., attached, attaching, etc.) may be construed as physically connecting a first component to a second component.

Herein, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

### II. Vehicle Architecture with Hardtop Roof Assembly

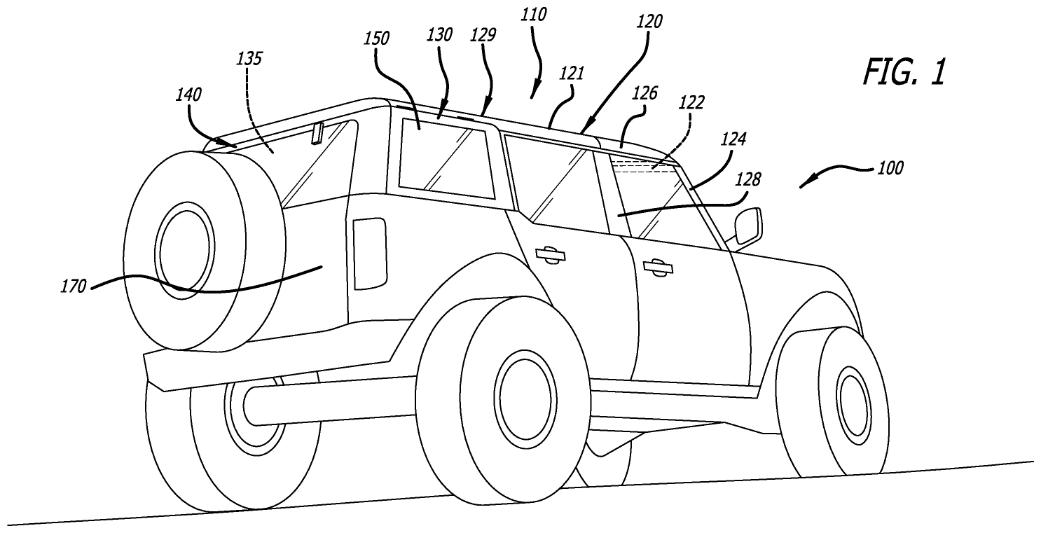

Referring to FIG. 1, a perspective view of an exemplary embodiment of a vehicle 100 installed with a hardtop roof assembly 110 is shown. The hardtop roof assembly 110 is configured with an architecture that supports disassembly during storage or transport and on-site assembly such as at a vehicle manufacturer. Herein, according to one embodiment of the disclosure, the hardtop roof assembly 110 includes a top roof frame 120, a pair of side roof frames 130 and 135, and a back roof frame 140. The top roof frame 120 includes a top roof panel 121 positioned above a passenger compartment of the vehicle 100 and supported by a body frame of the vehicle 100. In particular, the top roof panel 121 may be supported by components of the body frame including, but not limited or restricted to the following: a front header 122, windshield pillars (A-pillars) 124 attached to the front header 122, and/or side rails 126 coupled to different body pillars such as the A-pillar 124 and B-pillar 128. The side roof frames 130 and 135 and the back roof frame 140 are positioned rearward from a C-pillar (not shown) attached to the body frame.

The side roof frames 130 and 135 correspond to a first side roof frame 130 and a second side roof frame 135. The first side roof frame 130 is configured for attachment to a cut-out section of the rear side portion 129 of the top roof panel 121 as well as attachment to the body frame. Similarly, the second side roof frame 135 is similarly coupled to a complementary cut-out section of the rear side portion (not shown) of the top roof panel 121. Each of the side roof frames 130 and 135 are interposed between a corresponding C-pillar and D-pillar and house a rear side window 150.

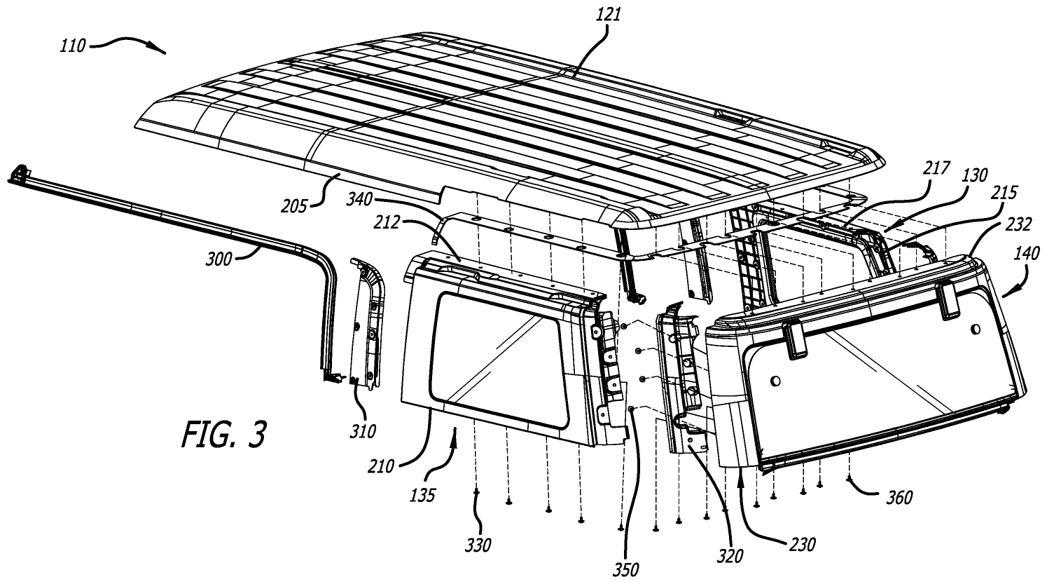

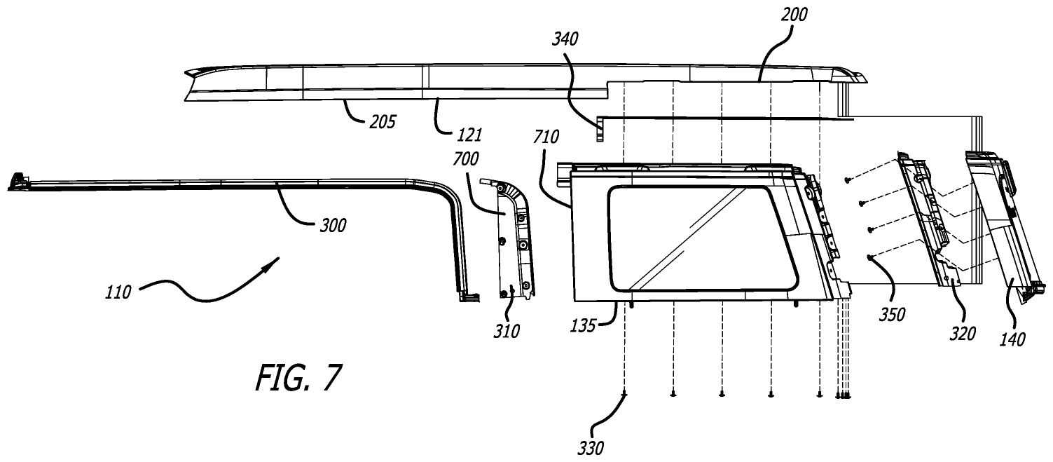

The back roof frame 140 is coupled (via the D-pillars (not shown)) to each of the side roof frames 130 and 135 so that the back roof frame 140, the side roof frames 130 and 135, and the top roof frame 120 collectively form the hardtop roof assembly 110. This architecture allows for the hardtop roof assembly 110 to be assembled and disassembled through removal of fastening mechanisms such as bolts positioned at different portions of these frames as shown in FIGS. 3 and 7. The back roof frame 140 is further attached to a tailgate 170 being a rear portion of the vehicle 100.

### III. Hardtop Roof Assembly Architecture

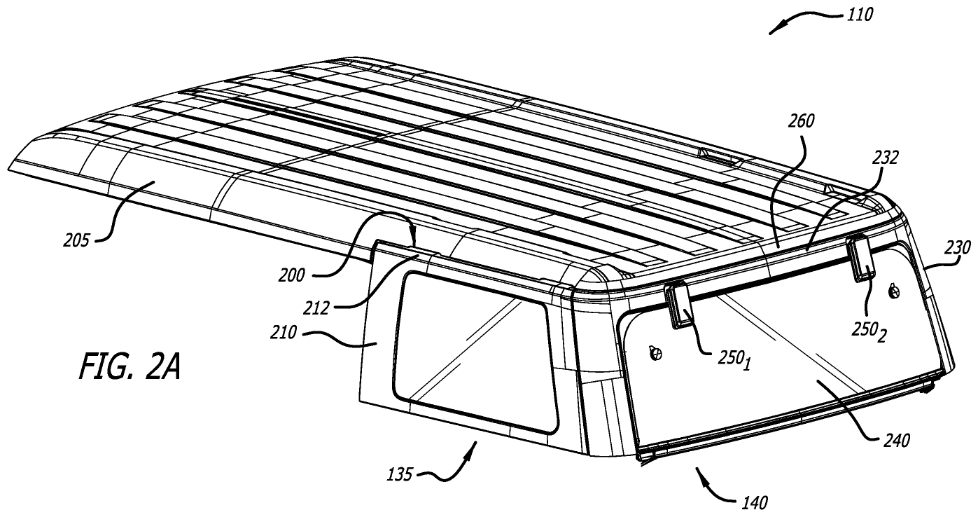

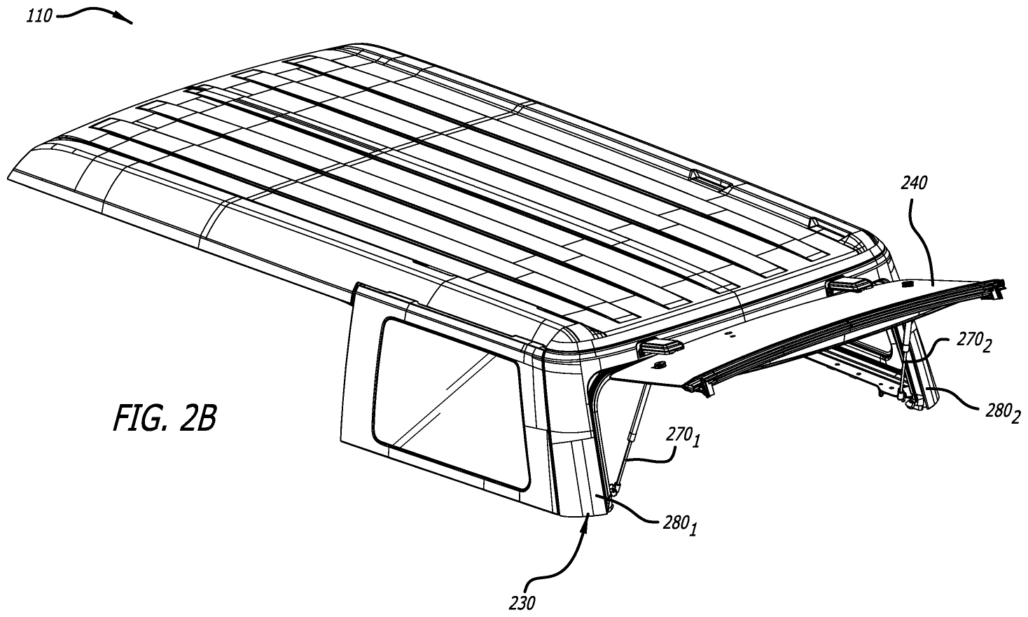

Referring to FIG. 2A, a first perspective view of an exemplary embodiment of an assembled, multi-component hardtop roof assembly 110 of FIG. 1 is shown. Herein, the second side roof frame 135 is positioned within a cut-out section 200 of the top roof panel 121 and is attached thereto. The cut-out section 200 may be sized with a width so that the curvature of an upper portion 212 of a side roof panel 210, being a component of the side roof frame 135, is aligned and consistent with the curvature of an edge 205 of the top roof panel 121 prior to the cut-out section 200. The hardtop roof assembly 110 further includes the back roof frame 140, which features a back roof panel 230, a rear window 240, and a plurality of pivotal brackets 250₁-250₂, which are arranged to enable the rear window 240 to pivot from an opened state to a closed state and vice versa. As shown, an upper portion 232 of the back roof panel 230 is positioned partially under and attached to a rear section 260 of the top roof panel 121. As a result, the top roof panel 121 and the back roof panel 230 are attached so that the exterior surfaces of the rear section 260 of the top roof panel 121 and the upper portion 232 of the back roof panel 230 generally provide a continuous and consistent contour.

Referring now to FIG. 2B, a second perspective view of an exemplary embodiment of the assembled, hardtop roof assembly 110 of FIG. 1 is shown, where the rear window 240 is positioned in an opened state. Herein, a pair of window support struts 270₁-270₂ are coupled to the back roof panel 230 and attached to an upper edge of the rear window 240 to enable pivoting of the rear window 240 from a closed state to the opened state as shown. More specifically, a first support strut 270₁ is attached to the rear window 240 and a first side member 280₁ of the back roof panel 230, and a second support strut 270₂ is attached to both the rear window 240 and a second side member 280₂ of the back roof panel 230. This allows the rear window 240 to be retained in the opened state until positioned in the closed state.

Referring to FIG. 3, an exploded view of the hardtop roof assembly 110 of FIG. 2 illustrating multiple components forming this assembly and their fastening scheme is shown. Herein, the top roof frame 120, the first side roof frame 130, the second side roof frame 135, and the back roof frame 140 are shown in a disassembled state prior to coupling and placement into an assembled state as shown in FIG. 2A. Herein, the hardtop roof assembly 110 includes weatherstripping, C-pillar seal retaining member, D-pillar member, the side roof frames 130/135, the back roof frame 140, and hardware (e.g., fasteners such as bolts, etc.) for attaching together these components to generate the hardtop roof assembly 110. Herein, a first (left) side perspective of the hardtop roof assembly 110 is shown for clarity. It is contemplated that these attachment scheme is equivalent for the components (e.g., side roof frame 130, weatherstripping, etc.) residing on the second (right) side of the hardtop roof assembly 110.

According to this embodiment of the disclosure, for the first (left) side of the hardtop roof assembly 110 includes a first (front) weatherstripping 300, a C-pillar seal retaining member 310, a D-pillar member 320, fasteners 330 for attaching the second side roof frame 135 to a U-shaped, second (rear) weatherstripping 340. More specifically, the first weatherstripping 300 is positioned under the lateral convex-shaped edge 205 of the top roof panel 121 and adjacent to the C-pillar seal retaining member 310. The C-pillar seal retaining member 310 is interposed between the first weatherstripping 300 and a front edge of the second side roof frame 135.

As further shown in FIG. 3, the second weatherstripping 340 is positioned to reside under the top roof panel 121 and is interposed between (1) a bottom surface of the top roof panel 121 and (2) the upper portions 212/217 of the side roof panels 210/215 and the upper portion 232 of the back roof panel 230. In particular, the second weatherstripping 340 may be positioned between fasteners (e.g., bosses, etc.) mounted to a bottom surface of the top roof panel 121, and upper connection brackets being part of the upper portions 212/217 of the side roof panels 210/215 and the upper portion 232 of the back roof panel 230.

According to this embodiment of the disclosure, the D-pillar member 320 is interposed between the side roof panel 210 associated with the second side roof frame 135 and the back roof panel 230. The D-pillar member 320 may be attached to the body frame, and in particular, to the back roof panel 230 associated with the back roof frame 140 via fasteners 350 inserted through connection apertures within the D-pillar member 320 and fasteners (e.g., bosses, etc.) placed within an interior surface of the back roof frame 140. Fasteners 360 are also utilized for insertion through the second weatherstripping 340 and attachment of the back roof frame 140 to the top roof panel 121. The above-described fasteners may consist of bolts, screws bosses, nuts, and/or any other fastening mechanisms that enable the top roof frame 120, the side roof frames 130/135, and the back roof frame 140 forming the hardtop roof assembly 110 to be decoupled for transport and/or storage.

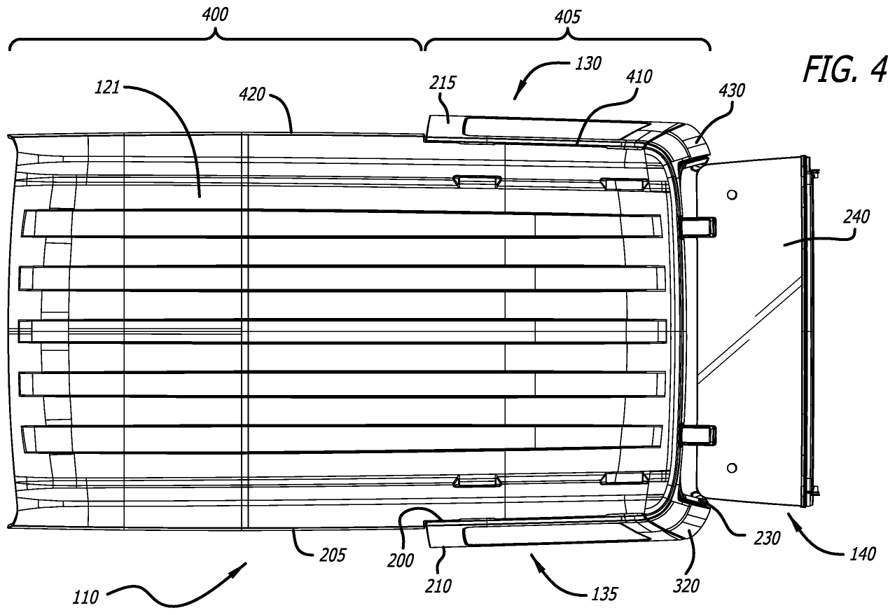

Referring to FIG. 4, an overhead view of the hardtop roof assembly 110 of FIG. 2 is shown, where the rear window 240 of the back roof frame 140 is oriented in the opened state. The hardtop roof assembly 110 includes the top roof frame 120, which includes the top roof panel 121 having a front portion 400 and a rear portion 405. The rear portion 405 includes the lateral, cut-out sections 200 and 410, where the cut-out sections 200 and 410 reduce the amount of extension from the edges 205 and 420 of the top roof panel 121 prior to the cut-out sections 200 and 410 positioned along lateral sides of the top roof panel 121. Therefore, the cut-out sections 200 and 410 provide reinforcement and additional stabilization between the top frame panel 121 and the side roof frames 130 and 135. As shown, the D-pillar member 320 is interposed between and attached to the side roof panel 210 and the back roof panel 230 and the D-pillar member 430 is interposed between and attached to the side roof panel 215 and back roof panel 230. The rear portion 405 of the top roof panel 121 is designed for attachment to the side roof frames 130 and 135 as well as the back roof frame 140.

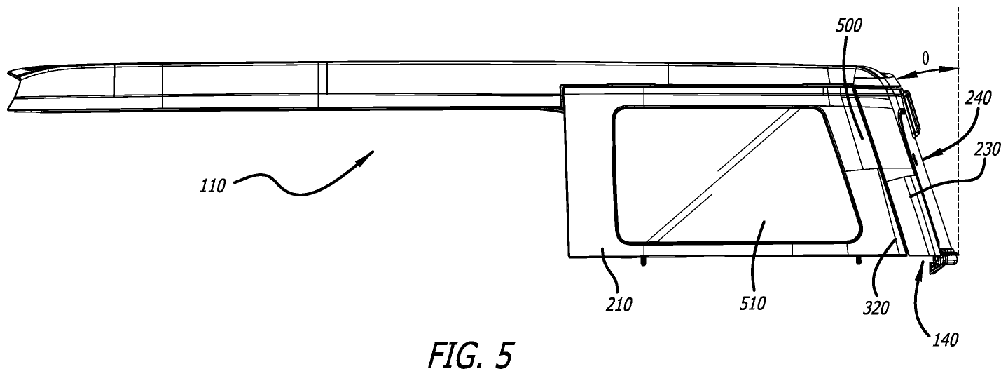

Referring to FIG. 5, a side view of the hardtop roof assembly 110 of FIG. 4 with the rear window 240 oriented in a closed state is shown. Herein, the side roof panel 210 is positioned adjacent to the back roof panel 230. The sloped, angular orientation of the back roof panel 230, based on part on an angular orientation of a rear segment 500 of the side roof panel (surrounding the rear side window 510) and/or the arrangement and connectivity of the D-pillar member 320 to the back roof panel 230 and/or side roof panel 210, provides an angular offset (θ) from vertical. As shown, “θ” may be any acute angle normally ranging from 15 degrees to 25 degrees from vertical for example. This angular arrangement provides for a more aerodynamic profile for the hardtop roof assembly 110 while retaining a sufficient sizing for the rear window 240 for the back roof frame 140.

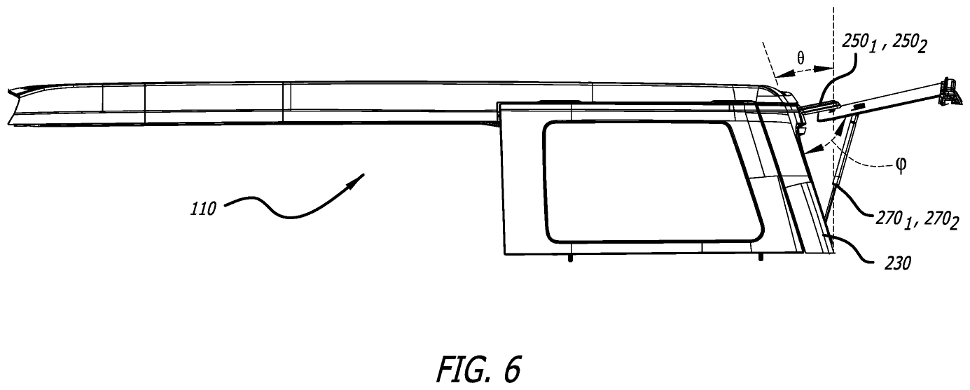

As shown in FIG. 6, a side view of the hardtop roof assembly 110 of FIG. 4 with the rear window oriented an opened state and held in place by the window support struts 270₁-270₂ is shown. Herein, the angular offset (θ) of the back roof panel 230 from vertical remains independent on whether the rear window 240 is placed in an opened or closed state, where “θ” may be 18° for example. However, the support struts 270₁-270₂ along with the support brackets 250₁-250₂ enable the rear window 240 to be pivoted by an acute angle (Φ), which may range between 60°-90° such as approximately anywhere between 70°-80° as shown.

Referring to FIG. 7, an exploded side view of the hardtop roof assembly 110 of FIG. 5 is shown. Herein, according to one embodiment of the disclosure, the first (left) side of the hardtop roof assembly 110 includes the first weatherstripping 300, the C-pillar seal retaining member 310, the second side roof frame 135, the D-pillar member 320, the second weatherstripping 340, and the back roof frame 140. The first set of fasteners 330 are shown for attaching the second side roof frame 135 to the second weatherstripping 340, and the second set of fasteners 350 are shown for attaching the back roof frame 140 to the D-pillar member 320.

More specifically, for installation, the top roof panel 121 would be positioned upside down. Thereafter, the first weatherstripping 300 is positioned under the convex-shaped edge 205 of the top roof panel 121 and adjacent to a front edge 700 of the C-pillar seal retaining member 310. Thereafter, the C-pillar seal retaining member 310 is interposed between the first weatherstripping 300 and a front edge 710 of the second side roof frame 135. The C-pillar seal retaining member 310 may be attached to the top roof panel 121 or may be initially attached to the second side roof frame 135. Prior to attaching the second side roof frame 135 to the top roof panel 121 via the first set of fasteners 330, the second weatherstripping 340 is positioned around a rear edges of the top roof panel 121, from the first cut-out section 200 to the second cut-out section 410 (see FIG. 4). Thereafter, the second side roof frame 135 is coupled to the top roof panel 121, the D-pillar member 320 is attached to the second side roof frame 135 and/or the back roof frame 140, and the back roof frame 140 is attached to the top roof panel 121 using the second set of fasteners 350. This assembly process continues for the second (right) side of the hardtop roof assembly 110.

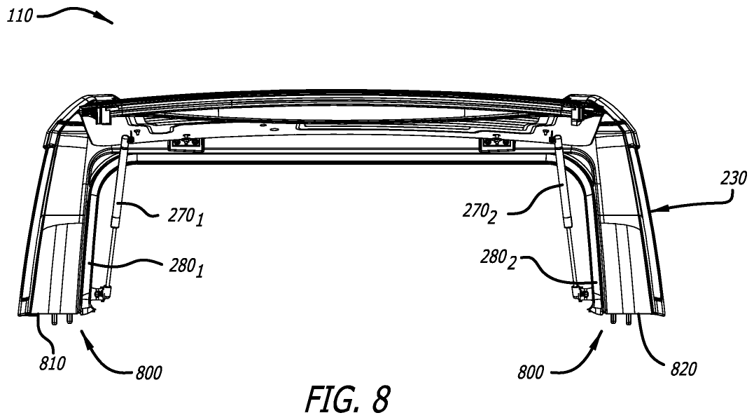

Referring now to FIG. 8, a rear view of the hardtop roof assembly 110 of FIG. 6 is shown. Herein, the first support strut 270₁ is attached to the rear window 240 and the first side member 280₁ of the back roof panel 230. Similarly, the second support strut 270₂ is attached to both the rear window 240 and the second side member 280₂ of the back roof panel 230. Fasteners or guides 800 are positioned on ends 810/820 of the first/second side members 280₁/280₂ to assist in attachment of the back roof panel 230 to the body frame (tailgate) of the vehicle.

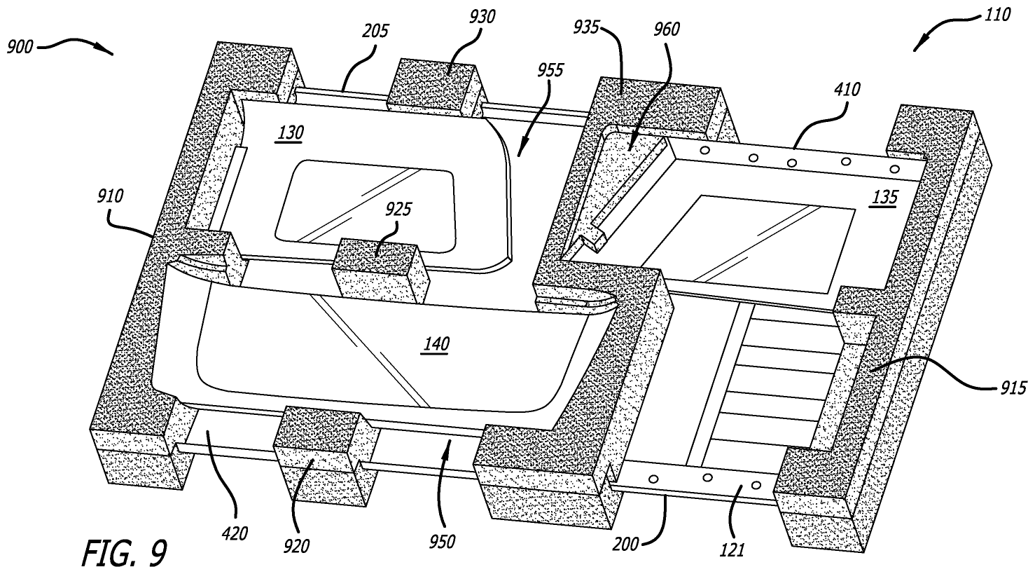

Referring now to FIG. 9, a disassembled hardtop roof assembly 110 with multiple components packaged for transport is shown. In accordance with one embodiment, a package 900 is sized to receive the top roof panel 121 positioned to operate as a base layer for the package 900. More specifically, the front/rear edges of the top roof panel 121 are secured by packaging supports 910 and 915, which are made of a material with shock-resistant characteristics such as Styrofoam™, air pillows, a type of polymer such as polyethylene, or the like. Additionally, portions of the convex-shaped lateral edges 205 and 420 of the top roof panel 121 may be secured by packaging support 910 while the portions of the cut-out sections 200 and 410 of these lateral edges of the top roof panel 121 may be secured by packaging support 915.

Additional packaging supports, such as packaging supports 920, 925, 930 and 935 for example, may be positioned to secure different sections of the lateral edges of the top roof panel 121 and to segment areas of the top roof panel 121 as different package areas 950, 955 and 960 to secure components of the hardtop roof assembly 110. For example, a first package area 950 is formed from a portion of the first packaging support 910 along with packaging supports 920, 925 and 935 and is sized to securely retain the back roof frame 140. A second package area 955 is formed from another portion of the first packaging support 910 along with packaging supports 925, 930 and 935 and is sized to securely retain the first side roof frame 130. A third package area 960 is formed from a portion of the second packaging support 915 along with a portion of the packaging support 935 for retention of the second side roof frame 135.

Herein the package 900 is provided with a low profile (e.g., less than 2 feet in height) to assist in transport of the hardtop roof assembly 110.

In the foregoing description, the disclosure is described with reference to specific exemplary embodiments thereof. It will, however, be evident that various modifications and changes may be made thereto without departing from the broader spirit and scope of the invention as set forth in the appended claims.

What is claimed is:

1. A vehicle hardtop assembly, comprising:
a top roof panel;
a first side panel configured to attach to the top roof panel via a first set of fasteners; and
a second side panel configured to attach to the top roof panel via a second set of fasteners,
wherein the top roof panel is detached from the first side panel by removal or loosening of the first set of fasteners and/or the top roof panel is detached from the second side panel by removal or loosening of the second set of fasteners.

2. The vehicle hardtop assembly of claim 1 further comprising:
a back rear frame configured to attach to the top roof panel via a third set of fasteners, the back rear frame includes a back rear panel and a rear window pivotally coupled to the back rear panel.

3. The vehicle hardtop assembly of claim 2, wherein the back rear panel is oriented with an offset angle from vertical.

4. The vehicle hardtop assembly of claim 3, wherein the offset angle ranges between ten and twenty-five degrees.

5. The vehicle hardtop assembly of claim 3, wherein the offset angle is approximately eighteen degrees.

6. The vehicle hardtop assembly of claim 2, wherein a first D-pillar component is positioned between the first side panel and the back rear panel and a second D-pillar component is positioned between the second side panel and the back rear panel.

7. A vehicle hardtop assembly, comprising:
a top roof panel;
a back rear frame configured to attach to the top roof panel via a first set of fasteners, the back rear frame includes a back rear panel and a rear window pivotally coupled to the back rear panel;
a first side panel configured to attach to the top roof panel via a second set of fasteners; and
a second side panel configured to attach to the top roof panel via a third set of fasteners,
wherein the back rear panel is oriented with an offset angle ranging between ten and twenty-five degrees from vertical.

8. The vehicle hardtop assembly of claim 7, wherein the top roof panel is detached from the back rear frame, the first side panel, and the second side panel by removal or loosening of the first set of fasteners, the second set of fasteners and the third set of fasteners.

9. The vehicle hardtop assembly of claim 7, wherein the offset angle is approximately eighteen degrees.

10. The vehicle hardtop assembly of claim 7, wherein a first D-pillar component is positioned between the first side panel and the back rear panel and a second D-pillar component is positioned between the second side panel and the back rear panel.

11. The vehicle hardtop assembly of claim 7, wherein the top roof panel includes a front portion and a back portion, the back portion includes a first lateral cut-out that is coupled to the first side panel and a second lateral cut-out that is coupled to the second side panel.

12. The vehicle hardtop assembly of claim 7, wherein the first set of fasteners include a plurality of bolts and complementary fasteners for the plurality of bolts, one or more pieces of weatherstripping in inserted between the plurality of bolts and the complementary fasteners.

13. The vehicle hardtop assembly of claim 12, wherein the complementary fasteners include a plurality of bosses secured to an inner surface of the top roof panel.

14. A transport package for a vehicle hardtop assembly, comprising:
a top roof panel positioned to operate as a base layer for the transport package;
a first package area positioned on the top roof panel, the first package area to receive and secure a back roof frame;
a second package area positioned on the top roof panel, the second package area to receive and secure a first side panel; and
a third package area positioned on the top roof panel, the third package area to receive and secure a second side panel.
